(19) United States
(12) Patent Application Publication
(10) Pub. No.: US 2011/0176391 A1
(43) Pub. Date: Jul. 21, 2011

(54) LOW FREQUENCY ACOUSTIC DETERRENT SYSTEM AND METHOD

(75) Inventors: Robert F. DeLaCroix, Penfield, NY (US); Joel Wojciechowski, West Henrietta, NY (US)

(73) Assignee: Hydroacoustics Inc., Henrietta, NY (US)

(21) Appl. No.: 13/007,558

(22) Filed: Jan. 14, 2011

Related U.S. Application Data
(60) Provisional application No. 61/296,152, filed on Jan. 19, 2010.

(51) Int. Cl. A01M 29/16; H04B 1/02

(52) U.S. Cl. 367/139

(57) ABSTRACT

The disclosed embodiments provide an acoustic deterrent system and a method for repelling sea mammals from a region of water. The system consists of one or more acoustic impulse sources spatially distributed underwater around the perimeter of the fish farm or other region to be protected. Each source is capable of generating an acoustic signal and a controller determines the firing time for each source to produce signals, which may include precisely timed wave trains of superimposed tones on a broadband low frequency signal, which are believed most effective in deterring seals, sea lions and other carnivorous mammals. The system may further include a sensing device to determine the presence of marine mammals so that the acoustic deterrent can be initiated on demand.

This application claims priority under 35 U.S.C. §119(e), from U.S. Provisional Application No. 61/296,152 for a “Low Frequency Acoustic Deterrent System and Method”, filed on Jan. 19, 2010 by Robert DeLaCroix, which is hereby incorporated by reference in its entirety.

The present disclosure is directed to an acoustic deterrent system and a method for repelling marine mammals (e.g. pinnipeds, such as seals and sea lions; and cetaceans, such as whales) from a region of water, such as the water in and around fish pens and similar aquaculture facilities, within commercial fishing and charter boat operating areas, and around ships where damaging whale strikes are likely to occur.

### BACKGROUND AND SUMMARY

The present disclosure is directed to an acoustic impulse deterrent system and method for repelling marine mammals such as seals or sea lions (herein referred to as pinnipeds, that being those mammals within a semi-aquatic carnivorous genus of mammals having limbs modified to be flippers), whales, or other aquatic mammals. Deterrent is taken to mean discouraging or preventing a mammal from entering into or staying in a particular area, and it is further noted that the principles of the disclosed embodiments can be equally applied for the deterrence of any mammal, albeit aquatic or terrestrial. However, the primary intent is to discourage the presence of predators within a defined region of water, such as in and around fish pens and similar aquaculture farm facilities, as well as within the working areas of commercial fishing and charter boat operations. Additionally, there is a growing concern that pinnipeds are attracted to ships and thereby are at risk of being struck and injured, whereby the broadcasted sound wave of the system keeps them at a safe distance from the propulsion means of the vessel.

Damage done by marine mammals to aquaculture facilities, fish stocks, recreational fishing, and conversely direct harm to themselves, as a result of a ship contacting the animals, is a severe and expanding predicament. In aquaculture facilities, pinnipeds, typically, but not limited to seals and sea lions, prey on the fish living in the submerged fish pens, resulting in loss of the fish stock and damage to the fish pens. Additionally, physical interaction between the marine mammals and commercial and pleasure boats can damage the boats or other equipment and potentially cause lethal injury to the marine mammals. Accordingly, the profits to commercial sport fishing vessel operators and open-range commercial fisherman are threatened by marine mammals who consume their hooked or netted fish, bait and chum. Therefore, it is important to the fish industry at large to provide an economic and effective solution to maintain and control the presence of such predators.

An embodiment of the disclosed deterrent system includes one or more underwater acoustic source(s), particularly acoustic impulse sources, strategically positioned within and/or around the perimeter of a fish farm. As will be described in further detail below there are a number of acoustic impulse sources, some of which are fluid-powered (includes liquid and air-powered devices), for example, air guns or water guns as known in specific industries.—In one embodiment an acoustic source, such as an air gun, is supplied with firing controls and a source of compressed air from either air storage tanks or directly from an air compressor. Firing control for the fluid-powered guns includes a controlled process to manage the individual firing sequence for each air gun so as to produce a single pulse or precisely timed wave train of broadband pulses, including superimposed pulses having random time spacing, to create the most offensive pulse widths, as further discussed below. The result is to provide low frequency, broadband signals which are considered to be most effective in deterring marine mammals, especially pinnipeds, as well as mitigating habituation by the continuously varied patterns of the signal. The system may also include a sensing device to determine the presence of the invading pinnipeds so that the air gun controller will fire only in the event of an approaching predator and direct the firing into the most effective location(s) and/or direction(s) about the aquatic farm. Additionally, it is noted that the air gun firing may also be triggered by sensing and analyzing a change in the swimming patterns of the fish within the farm, as they are startled by the presence of a potential predator. Attempts have been made to provide an impenetrable enclosure; however, these structures are costly, heavy, difficult to manage, and sometimes can be shown to be non-impervious.

Other deterrent technologies have been deployed as means to reduce the damage to fish farm enclosures from the attacks of seals and sea lions, and the subsequent fish kill within those enclosed areas. They include; electrical, optical, and electromagnetic devices, along with chemical agents and pyrotechnics. While some of the aforementioned deterrent devices may be effective when used on land, they have not been entirely successful when applied under water due to attenuation and the resulting very high power requirements. In the case of chemical agents, the significant dilution in the water severely limits their effectiveness in fending off any pinnipeds. Discrete barriers, such as fences, break walls and jetties tend to come at a high cost and generally interfere with normal fish farm and boating activities. Projectiles from guns are also ineffective under water because of their limited range and difficulties in accurately aiming the projectile when fired from above the surface of the water.

Mammals, by nature, have outstanding hearing in or out of the water with a frequency range of about 20 Hz to 30 KHz. with a maximum sensitivity of around 75 dB; therefore, the transmission of underwater audible sounds as warnings or irritants is considered a promising method for repelling marine mammals. One such acoustic deterrent includes introducing sounds of predators, such as killer or gray whales, in the proximity of fish farms. This method has been shown to work for a limited duration as the marine mammals learn from experience that there are no predators and all too soon realize that the sounds are synthesized, or otherwise become desensitized to the sounds.

The effects of acoustic energy on seals, sea lions or other pinnipeds depend largely on the acoustic source and, more specifically, the frequency, period and amplitude of the acoustic source. High frequency acoustic signals are often used as a deterrent to seals and sea lions; however, again, after some time, they become desensitized to the sound. Moreover, hunger has a tendency to override the annoyance caused by the high frequency acoustic signals and predators earnestly return to the fish pens to feed. In fact, it is believed that after prolonged use of these systems; the signals may actually act to signify the presence of food and thereby alert the mammals to the presence of fish pens, in a manner similar to a Pavlovian response. Furthermore, working in the high frequency audible spectrum is not only an impractical deterrent, but the attenuation effects on high frequencies in water severely compromise propagation of the sound and; therefore, the range of coverage.

A variety of low frequency acoustic source options exist including; single tone or swept tone electro-mechanical sources, explosives, sparker sources (also known as pulse power or plasma sources), and high pressure systems that discharge either water (water guns) or air (air guns). Electro-mechanical sources at low frequency and high power may be subject to cavitation in shallow water, and can be quite large and heavy; and therefore have limited deployment options. Explosives, such as seal bombs, are low cost and have been used with some degree of success. However, they are dangerous to handle and are also labor intensive and high maintenance in that a person must be dedicated to the task of discharging and replenishing each explosive. Sparker sources require a voltage as high as 20 KV and; therefore, are inherently dangerous around water, degrade over time, are limited in deployment flexibility, and generate radio-frequency interference.

Acoustic signals are capable of causing auditory and physiological effects on the body of the marine mammals involving various air-filled cavities such as ears, eyes, lungs and the abdomen. An acoustic deterrent system should be as uncomfortable as possible for the predatory mammal, without inflicting any enduring injury. To that end, low frequency, broadband transmissions in the 20 to 250 Hz spectrum, from an impulsive sound source, such as an air- or water-gun, are believed to provide a promising and safe deterrent effect by overcoming any long term impairment as well as resolving the aforementioned technical shortcomings of other techniques.

In regard to water guns verses air guns, they both exhibit deployment flexibility as to various arrays, sizes and shapes and are convenient to use due to the use of a high pressure pneumatic source, in lieu of pyrotechnics. Air guns may have advantages over water guns, however, because the operating frequency of the water gun is generally higher than the believed preferred acoustic bio-effect induced by the lower frequencies associated with the air gun. Nonetheless, both water and air guns can be configured into various array sizes and shapes.

Air guns are a mature technology that is widely accepted in the marine seismic industry to search for oil fields beneath the ocean's floor. Accordingly, based on safety and environmental issues, the marine seismic industry has been motivated to move away from pyrotechnic generation of an impulse sound wave and have adopted air guns as an acoustic source. Furthermore, air guns do not pollute the environment since they only discharge compressed air, with no chemical or plasma residue. Air guns are not expended when used, as contrasted with explosive charges for example, and their performance does not vary over time from either wear or component degradation as is the case with some plasma discharge devices. Air guns can be used individually or assembled in an array or cluster to establish a sound vector, depth and volume of the sound wave. Most air gun system components, such as air compressors, pneumatic controls and air energy storage units, are based on established technologies. Since these components have been used for in offshore seismic oil exploration, they have low development cost and risk, have proven to be cost effective, exhibit high system reliability, and have a long service life with established maintenance and a proven safety record.

Air gun-based deterrent systems provide a great deal of flexibility in generating an acoustic impulse signal, both in terms of intensity and in the specific signal characteristics. The disclosed systems and methods, also referred to herein as an Aquaculture Predator Protection System (APPS), generate a low-frequency, broadband acoustic impulse specifically programmed to discourage the predatory mammals from feeding in the aquaculture area. Depending upon the particular embodiment, the impulse may also be directed or omnidirectional. As further disclosed herein, the output level and rate at which pulses are transmitted are both adjustable and can be automated and controlled to maximize the effectiveness in fending off pinnipeds. When multiple guns are employed in an array, the broadband output pulses can be superimposed by regulating the pulse width and magnitude of the sound wave. An individual air gun generally provides an omnidirectional acoustic signal and therefore can address multiple mammals approaching a fish farm from most any direction. A significant attribute of the disclosed systems is that it does not have a tendency to cavitate and hence operates effectively in shallow water environments where seals, sea lions or other mammals are more likely to be present or concentrated.

The effects from the impulsive sound signals generated by an air gun on marine mammals in shallow water have been documented. The following: (i) “Assessment Of The Potential For Acoustic Deterrents To Mitigate The Impact On Marine Mammals Of Underwater Noise Arising From The Construction Of Offshore Windfarms,” Jonathan Gordon, David Thompson, Douglas Gillespie, Mike Lonergan, Susannah Calderan, Ben Jaffey, and Victoria Todd, SMRU Ltd, Gatty Marine Laboratory, University of St Andrews, St Andrews, KY16 8LB, 82 p, July 2007; (ii) “Acoustic Deterrence Of Harmful Marine Mammal-Fishery Interactions”: Proceedings Of A Workshop Held In Seattle, Wash., 20-22 Mar. 1996, Reeves, Randall R., Robert J. Hofman, Gregory K. Silber, and Dean Wilkinson, U.S. Dep. Commerce., NOAA Tech. Memo NMFS-OPR-10, 68 p. 1996; (iii) “Acoustical Deterrents in Marine Mammal Conflicts with Fisheries” A Workshop Held Feb. 17-18, 1986, at Newport, Oreg., Bruce R. Mate and James T. Harvey, Editors, Oreg. Sea Grant, ORESU-W-86-001, 120 p, 1987; and (iv) “Coming to Terms with the Effects of Ocean Noise on Marine Animals,” Mardi C. Hastings, Applied Research Laboratory, Pennsylvania State University, State Collage, Pa., 16804, Acoustics Today, 13 p, April 2008, all of which are hereby incorporated by reference for their teachings, suggest that marine mammals showed evidence of an immediate fright/flight response, when exposed to an air gun signal, followed by a rapid change in their heart rate (for pinnipeds, going down dramatically from 35-45 beats per minute (bpm), to less than 10 bpm). They typically exhibited a strong avoidance behavior, by swimming rapidly away from the air gun system while changing their dives from foraging to transiting. As noted, the typical avoidance response for the marine mammal was to move away from the source in fright; however, within about two hours after the exposure to the air gun, most of the mammals returned to their normal behavior patterns of foraging. Further studies have shown that the behavioral response within a species will vary considerably from one seal to another. It is thought that this is caused by a number of factors including; any previous experience with air gun impulse signal, hearing sensitivity, age, social status, or its general behavioral personality. In light of the fact that these mammals are capable of learning, they seem to habituate to the air gun because no aversive events are associated with the signal and possibly they adapt to the sound waves over time because they are predictable and uniform.

The present disclosure is directed to an acoustic deterrent system and a method for repelling marine mammals from a region, such as the water in and around fish pens and similar aquaculture facilities, within commercial fishing and charter boat operating areas, or around ships where marine mammals congregate and are possibly injured. The system is repeatable, controllable and scalable and includes a stationary, acoustic impulse source, which in one embodiment may be a single air gun or an array of air guns, spatially distributed underwater about the perimeter of protected water region. In the alternative, the deterrent system can be mobilized and placed within a floating structure. In either case, the air guns simply require a pressurized air source and a controller that includes a microcontroller, operator interface and I/O ports for the guns and the sensors.

In accordance with this disclosure, described herein is a method for deterring mammals from remaining in a region of water, comprising: detecting the presence of mammals near the region using a sensor; and in response to such detection, using low-frequency, broadband acoustic signals supplied by at least one fluid-powered, acoustic impulse source regulated by a controller.

In accordance with another aspect of the disclosure, there is provided a system for repelling marine mammals from a region of water, comprising: at least one fluid-powered acoustic impulse source deployed in the water in proximity to a perimeter of the region; and a controller, controlling the operation of said acoustic impulse source to produce low-frequency, broadband acoustic signals.

### BRIEF DESCRIPTION OF THE DRAWINGS

FIG. 1 is a schematic illustration of the acoustic deterrent system as deployed in an open field aquatic fish farm;

FIG. 2 illustrates an exemplary acoustic impulse source as a typical 10 cubic inch (cu-in.) air gun;

FIG. 3 is a cross sectional view A-A′ of the air gun previously shown in FIG. 2;

FIG. 4 is an exemplary schematic of a control system employed in accordance with the disclosed embodiments;

FIG. 5 is a graphical example of the Sound Pressure Level from an Air Gun at 3,000 psi from a 10 cu-in. air gun at a depth of 52 ft.;

FIG. 6 is a graphical rendition of the Energy Spectrum Level from an Air Gun at 3,000 psi from a 10 cu-in air gun at a depth of 52 ft.;

FIG. 7 is a recording of the Sound Pressure Level from an air gun at a depth of 20 feet at 2,400 psi; having a receiver 60 yards removed from the source to monitor a variable period produced by the air gun controller;

FIG. 8 is a representation of the base tones and their harmonics generated by the air gun controller by delaying the successive firings represented above in FIG. 7;

FIGS. 9-10 are illustrations of a an alternative embodiment of the acoustic deterrent system;

FIGS. 11 and 12 are illustrative examples of alternative controllers in accordance with alternative embodiments of the acoustic deterrent system;

FIG. 13 is a schematic illustration of a pressurized air source in accordance with one embodiment of the acoustic deterrent system; and

FIG. 14 is an illustration of a pressurized air source for an embodiment of the acoustic deterrent system.

The various embodiments described herein are not intended to limit the scope of the disclosure to those embodiments described. On the contrary, the intent is to cover all alternatives, modifications, and equivalents as may be included within the spirit and scope as defined by this disclosure and the appended claims.

### DETAILED DESCRIPTION

In describing various elements in relation to the embodiments disclosed herein, it will be appreciated that various alternative acoustic impulse sources may be employed in different situations. As used herein, the term fluid-power is intended to apply to air or gas (e.g., pneumatic) as well as liquid power (e.g., hydraulic) sources. Aspects of the deterrent system and method that are enabled by the disclosed embodiments include; (i) repeatability, (ii) controllability and (iii) scalability.

In order to provide a repeatable deterrent, the acoustic impulse sources should be able to operate over time, without significant degradation due to the hostile aquatic environment in which they are used. In order to be controllable the acoustic impulse sources are, as described below, controlled by, or respond to, a firing controller that determines a point in time when the sound sources are fired, as well as the manner and timing of firing, in order to produce the desired pulse(s) or a wave train that will be most suitable to deter the predatory mammals. Lastly, it is believed that the disclosed embodiments are generally scalable either via the addition of acoustic impulse sources, meaning that larger regions may be protected with the deterrent systems by having additional impulse sound sources, or via increased power or size of the acoustic source for influence over a larger region or for increased influence over a given region.

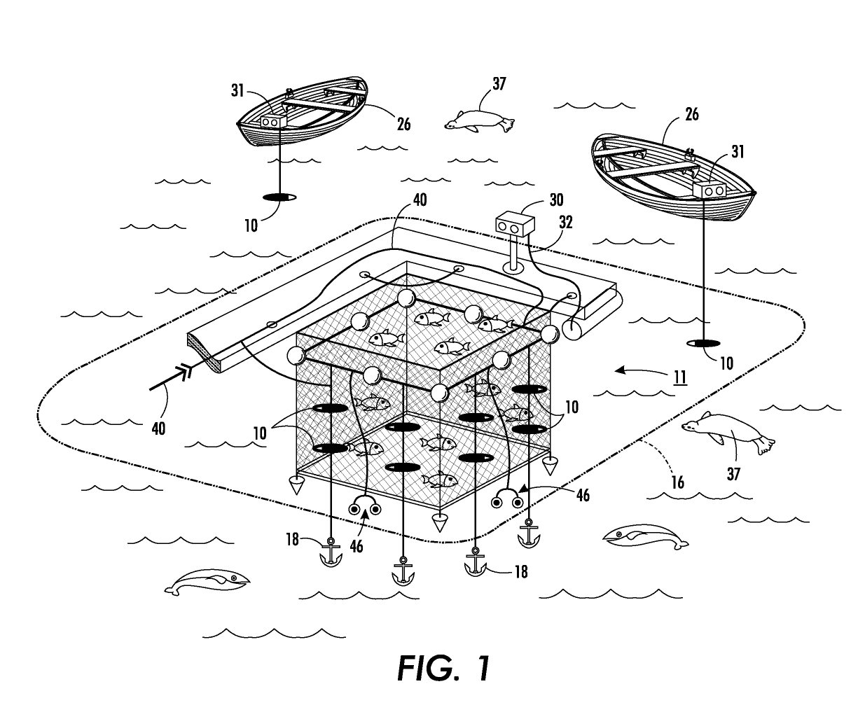

Now turning to FIG. 1 which schematically illustrates a fish farm using an embodiment of the acoustic deterrent system as disclosed herein. The system as shown includes acoustic impulse sources such as one or more air guns 10 deployed to provide an acoustic barrier around at least a portion of the fish cage 11. The number, and specific location and depths, of the acoustic impulse sources, such as air guns 10, are dependent on the specific geometry of the fish cage 11 and the surrounding area, including the distance between the cages of the aquaculture facility and the surrounding underwater topography. The deployment depth of the air guns 10 is determined by the overall depth of the water and the composition of the bottom of the lake or ocean. It may be necessary to use more than one air gun in a vertical string at different depths in order to longitudinally extend the effectiveness of the acoustic barrier from the surface to the bottom of the water. Air guns 10 are deployed either from existing in-water structures, about perimeter 16 of fish cage 11 or supported by means of rafts, buoys or piers. Additionally, a portable deterrent unit 31 installed on boat 26 provides for an extended range and possibly provides for a first line of defense during a pinnipeds attack. The boat-based or mobile embodiment will be described in further detail below. This portable configuration is also advantageous as an on-board, self-contained deterrent system for use in open water such as with fishing boats and the like.

FIG. 1 further illustrates an exemplary acoustic deterrent control system including gun firing console 30, air hose 40, sensors 46 and control cable 32. The specific location and configuration of the various components is application specific and will, for the most part, be predicated upon the size and characteristics of the fish farm installation. As depicted, an array of fluid-powered guns 10 is suspended on lines that are attached to anchors 18 and further connected to the air gun firing console 30, either through electrical cables 32 or via a wireless link (not shown). The air guns are supplied with compressed gas (typically air) by a high-pressure source such as from high pressure storage tanks or an air compressor (not shown) via pneumatic hoses 40 running between guns 10 and a high pressure air source. A sensor system, comprised of predatory mammal sensors 46, which may include: sensors suitable for sensing motion (e.g., infra-red detection) or sound (e.g., above or underwater microphones, hydrophones, aqua-phones, etc.), sonar systems, or imaging devices (e.g., above or underwater cameras), one or more of which can be deployed around the targeted region to detect the presence of pinnipeds or other marine mammals. These commercially available sensors 46 provide information to both the air gun controller 30 and to an operator indicating where approaching mammals have been detected. It is further contemplated that the firing of the acoustic source(s) may be triggered by sensing and analyzing a change in the swimming patterns of the fish within a farm enclosure as they are startled by the presence of a potential predator.

Also contemplated herein is the utilization of a sensor(s) to monitor the performance of the deterrent system and to feed this information back to a controller. Such a system may be particularly useful in a remote or unmanned aquaculture facility. In one such embodiment, a hydrophone or similar acoustic sensor could be used to not only detect the presence of mammals, but perhaps to monitor the acoustic impulses output by the acoustic impulse source. Monitoring may be for the purposes of simply confirming operation or for purposes of “tuning” a system at the time of installation. For example, the hydrophone could be placed outside the region to be protected and used to assure that the impulse from one or more adjacent sources is received at or registered by the sensor. Another contemplated use for sensors could be to confirm the deterrent effect of a pulse, pulse train, etc. by determining if the mammals detected have been deterred or driven off by the firing of the acoustic source(s). Although it is unlikely that the acoustic environment around an aquaculture facility would change enough over time to monitoring after installation of such a system, the subsequent use to confirm or track the deterrent effect of the system may prove advantageous.

The air gun firing controller 30 can be locally or remotely located in an office or control center, wherein response to input from predatory sensors 46 is analyzed to provide a firing trigger, or in response to a manual trigger, a microprocessor or similar programmable device within controller 30 determines the firing time and order to produce precisely timed wave trains having superimposed broadband pulses. The controller 30 thereby allows for either a direct manual control of the firing sequence, from the console or a remote handheld switch, or a programmatic control for an automatic firing sequence, which may be based upon input from sensors 46. The net result is production of low frequency broadband signals which are effective in deterring marine mammals 37, as well as continuously varying the signal period to minimize the habituation of the mammals to the acoustic signals when needed.

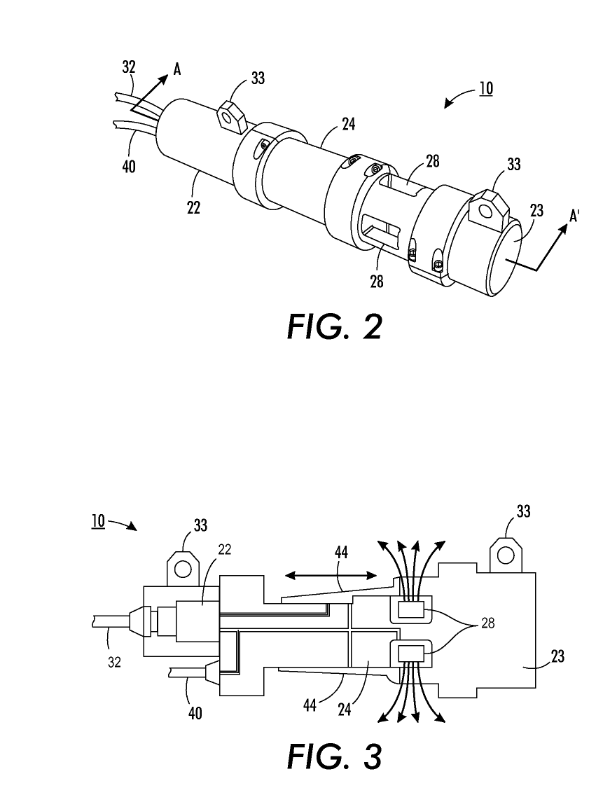

Referring to FIG. 2, in view of FIG. 3, illustrated therein is a close up view of a typical air gun 10 for use in the acoustic deterrent system for repelling marine mammals. The air gun, which may be a Bolt Technologies Model No. LL-2800, but can be produced by other manufacturers (e.g. Sercel, I/O), has several external features, including hangers 33 or similar attachment mechanisms as a securing means, as well as a means for connecting a string of air guns together, cable 32 for firing control and pressure hose 40 for the pressurized fluid power supply. Depicted therein is at least a 10 cubic inch air gun weighing about 40 pounds and having a diameter of about 5 inches. Based on a single moving sleeve or poppet reliable and repeatable operation is achieved, where maintenance is not required until after at least 300,000 firings, with a typical life cycle in excess of 1,000,000 firings. It should be noted that the range of coverage can be extended by increasing the volumetric capacity of the firing chamber, thereby transferring additional energy into the surrounding water.

FIG. 3 shows the internal operating features for the air gun pictured in FIG. 2 and is similar in design to a typical poppet-valve air gun. It will be appreciated that there are various types of controllable acoustic sources, including fluid-powered (air and water) “guns” as well as explosive devices such as seal bombs, detonation cord, and the like, that may be suitable for the generation of acoustic signals. As previously noted, the advantage of fluid-powered devices is that they may be repeatedly cycled and controlled to produce variable and desired signals. Notably, various fluid-powered “guns,” or a combination of types, may be employed within the array of guns 10. In the case of an air or pneumatic-type gun 10, when the gun is fully charged, sleeve 44 functions as a slide valve—sliding between an open and closed position. Once chamber 23 reaches a desired pressure, typically between about 500 and 5,000 psi, solenoid valve 22 is closed. A firing signal can then be applied through cable 32 causing solenoid valve 22 to open, which in turn pressurizes the firing chamber 24, and moves sleeve 44 to release high pressure air directly from main chamber 23 into the surrounding water through orifices 28. Once the air pressure has been instantaneously released into the water it expands rapidly and displaces a volume of water that produces a large impulse or explosive sound creating air pockets that oscillate as the energy is dissipated in less than 100 msec. In order to re-charge the gun, a return spring (not shown) within chamber 24, and the reduced pressure in main chamber 23, cause sleeve 44 to slide closed and air pressure once again enters from inlet 40 into main chamber 23 to “reload” gun 10 to the original system pressure, in less than a second.

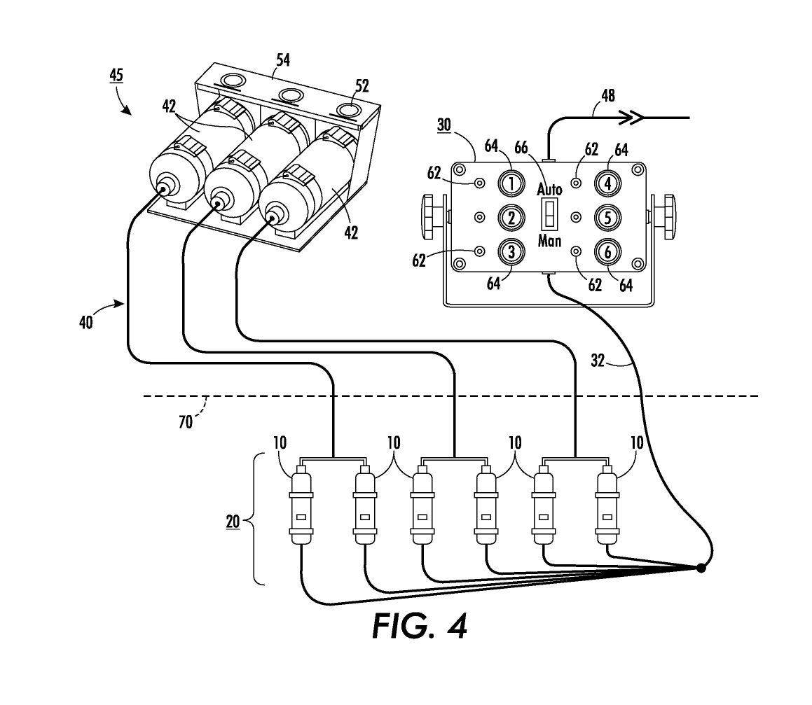

FIG. 4 shows an exemplary representation of an air gun control system 45 to fire the air guns 10 within array 20. As disclosed above, controller 30 can be located at the air gun deployment site, in a central command station or in a floating vessel. Control system 30 includes a microcontroller having programmable memory that implements not only the operation of the system (e.g., acoustic impulse source, firing frequency, timing, duration and pattern), but also provides a user-interface or similar means (e.g., control panel, console, buttons, etc.) by which an operator may interact with the functions of the system. Rudimentary controls would include the ability to fire one or more, or even all air guns either locally or via a remote control, enable or disable the system, as well as the ability to perform diagnostics to test individual components and their placement. In operation, the control system 30 communicates, either via hard wire or through a wireless connection, to each air gun 10 within array 20 and controls the firing sequence for each air gun (e.g., timing relative to other guns, delays between pulses, etc.). The operator has the option to manually fire the air guns 10 or to utilize a computer controlled, automatic firing sequence—which may include a programmed sequence that is in direct response to sensor inputs indicating the presence of mammals. With precise timing of the firing, the time delay between the firing of the air guns can be adjusted such that the combined acoustic signals from several air guns can be selectively directed within a specific direction or constructed for a specific acoustic signature, thereby increasing the bio-effect on the intruding marine mammal approaching from any specific direction. In addition, this precise control of the air gun firing times can be used to generate a wide variety of wave formats, as further described below.

Also depicted in FIG. 4 is a plurality of buttons in a simplified manual controller, wherein the firing of each of the guns 10 may be controlled via signals transmitted along cable 32. For example, depressing controller button 64 (Button 1, 2, 3 . . . N)) would result in the firing or the associated gun 10. A status light (e.g., light emitting diode) or similar visual signal 62 is represented next to each of the buttons 64 to indicate the status of the respective gun. The light may be used in a single color to indicate that the gun is functional, or it may be used in a number of colors to indicate the gun's state such as charged (ready for firing), firing confirmation, recharging, etc. Although shown as a simple button/light interface, it will be appreciated that the controller may further include a display, or permit connection to a computer display, that will provide similar indications of status as well as enable further controls or functionality that may be exercised by a user. Furthermore, the controller may provide a display in response to determining the presence of mammals, ranging from a simple indicator to a more detailed output based upon analysis of the sensors (e.g., showing an approximate location of the mammals detected).

Controller 30 can also process information provided by marine mammal detectors 46, in addition to generating wave trains as described above, to fire only those air guns that are closer to, or in the anticipated path, of a predator 37. This will conserve energy by reducing the compressed air consumption and minimize acoustic exposure to the fish or other food-stock by limiting non-productive acoustic stimulation. This controller can also be used to control other acoustic deterrent systems including water guns or any other devices that may be fired or triggered by a controlled electrical signal.

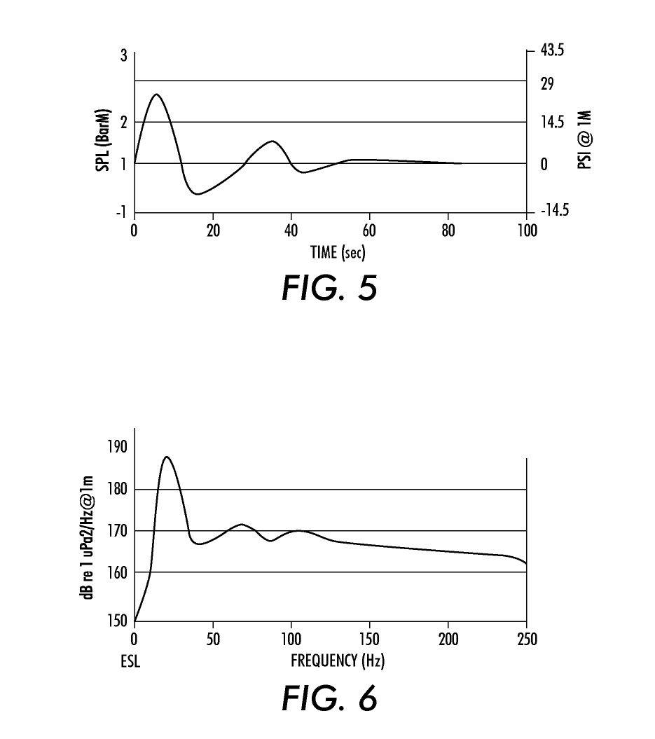

FIG. 5, in conjunction with FIG. 6, graphically represents the sound pressure level (SPL) as a function of time using the sound pressure levels generated from an air pressure of 3,000 psi, within a 10 cubic inch (cu-in.) air gun, at a depth of 52 ft. As recorded, a broadband, impulsive signal is generated whose energy is spread over a wide frequency spectrum. For this relatively small air gun of 10 cu-in., the measured far field sound pressure level at 3,000 psi approaches 2.5 BarM (36.25 psi @ 1 m) and approaches 8 BarM with a 300 cu-in. chamber. Notably, the energy spectrum level (ESL) of FIG. 6 approaches 190 dB re 1 microPa²/Hz @ 1 m This recorded dissipation of the sound pressure is a quantitative measurement of the loss of sound intensity between two points, normally the sound source (IS) and a distant receiver (IR). If IS represents the intensity of the source measured at 1 m, and IR is the intensity at the receiver, then the propagation loss (PL) is a logarithmic function as represented by PL=10*log(Is/IR) for intensity (or 20*log(Is/IR) for pressure). The speed of sound in water, and; therefore, the pressure at a specific time interval, is further affected by physical obstacles resulting in reflection, refraction, interference and diffraction. Additional influences on sound pressure level propagation are dependent upon the effects of spherical and cylindrical energy dissipation, water salinity, temperature, tides, waves and bottom composition. Weather and ambient noise, including biological sounds also have an effect on the sound wave as perceived by the pinnipeds.

In reference to the energy spectrum level, the output of energy of the air gun can be modified by altering the system pressure, and even though the frequency of the peak energy declines as the air pressure is increased, it remains within the effective frequency range for deterring marine mammals. The sound pressure level from an air gun can be varied by changing either the volume or pressure, or both, of the air stored within the air gun. With 3,000 psi pressure in the chamber, the peak pressure generated by an air gun increases as the volume of compressed gas is increased-going from near 3 BarM with the 10 cubic inch chamber, for sea lion control, to nearly 8 BarM for a 300 cu-in. chamber.

Marine mammals, such as sea lions, are fairly intelligent and, therefore, may habituate to repetitive acoustic signals. Accordingly, the gun control system 30 may also be designed to be capable of varying (cyclic or random) the sequence of firing one or more of the fluid-powered guns so that the acoustic environment is continually changing. A sequence is one or more firings with variable time intervals between the firings, whereby several sequences may be defined and repeated in a continuously variable order. As one example, a variable, low frequency output may be achieved by emitting a pulse train with a variable repetition rate. In addition, controller 30 determines the firing time for each gun 10 in array 20 and adaptively corrects for changes in air gun firing latency (the time difference between the firing signal and the actual firing of the air gun) to produce precisely timed wave trains. The synthesized base tones and their harmonics on the broadband signal are subsequently derived from the firing delay times. It will be appreciated that while the schematic illustration of FIG. 4 depicts the exchange of control signals between the controller 30 and the air gun array 20, similar communications may also be made to the air pressure source 45, in order to monitor and/or adjust the pressure output of regulator 54, such that the nature of the emitted acoustic signal from one or many guns may be controlled via both timing as well as pressure magnitude.

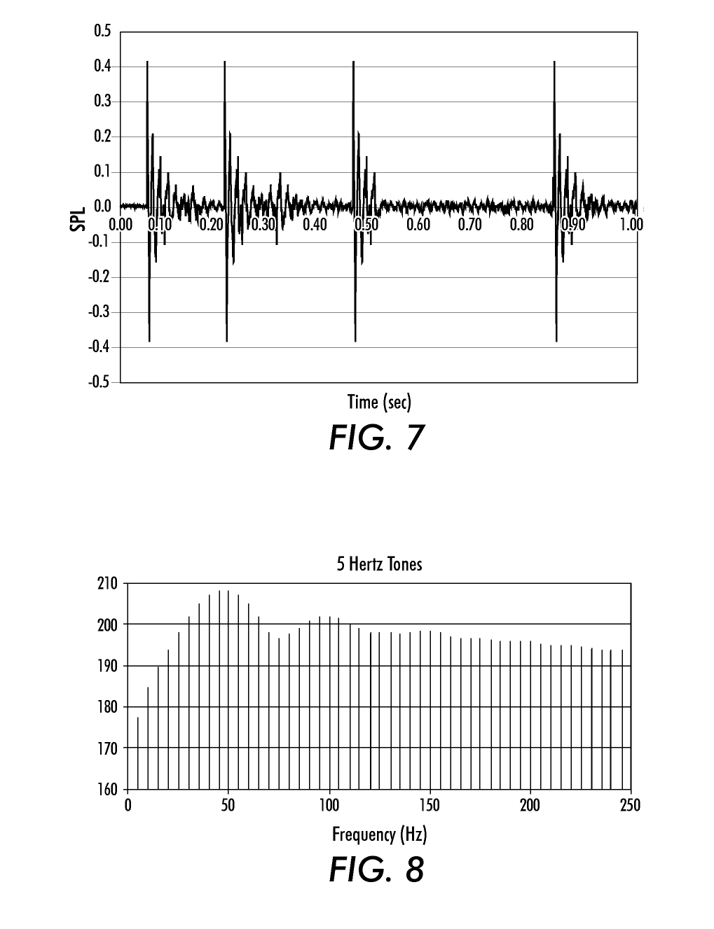

An air gun sound pressure level output wave train of four pulses is shown in FIG. 7, within a continuous train of pulses generated by the controller, providing an unique firing interval to the air gun. The effectiveness of the pulse can be increased with a constant pressure, by firing multiple air guns having a precisely controlled separation between each firing. Therefore, different numbers of pulses, with varying delay times between them, can be implemented as shown, whereas the time between the pulses can be as short a fraction of a second to as long as many minutes, in order to reduce habituation of seals, sea lions, etc. to the deterrent system.

Turning next to FIG. 8 there is shown a graphical representation of how a base tone and its harmonics can be generated by precisely delaying successive firings of portions of the air gun array 20. If desired, the frequency of these tonals can be selected to have the maximum effect on the seals or sea lions. The broadband character of the air gun impulsive signal produces tones to well beyond 1,000 Hz. The 5 Hz tones in this particular graph may be generated by a plurality of guns discharged at a rate of one pulse per second with a 0.20 second delay between each group.

The effects of the mammal deterrent system on the fish stock within cage 11, are intended to be minimal, whereas several deterrent embodiments described herein further contemplate that the acoustic signal is, at least to a certain extent, directed or focused away from the pen and that the control system 30 may be fine tuned or controlled relative to the feeding or breeding cycle of the fish in an aquaculture region.

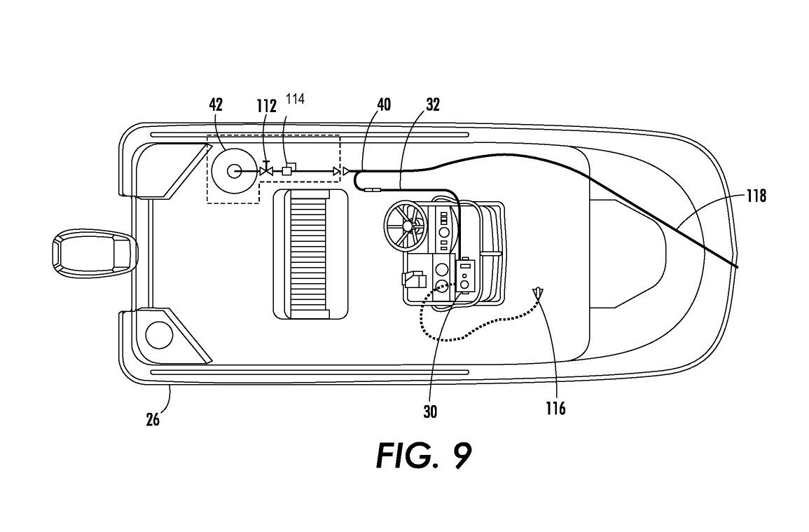

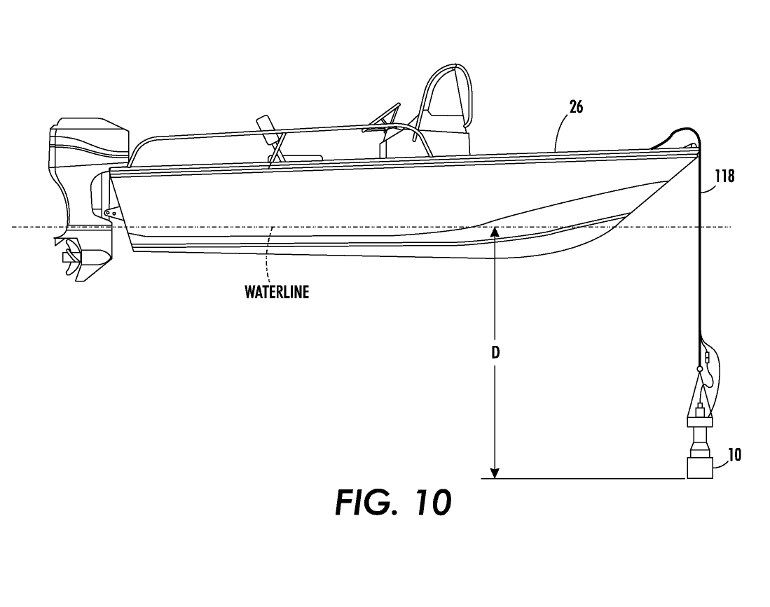

Turning now to FIGS. 9-10, depicted therein is a movable deterrent system associated with a boat or similar vessel 26. When deployed from a vessel in an open-water situations (e.g., mammal deterrent near commercial fishing, sport-fishing, etc.), the control system 30 may further include a global positioning system to track and/or provide coordinates having a direct relation to the activity being carried out. In such cases, the controller may be programmed to further produce deterrent acoustic signals based upon geographical position, for example in relation to nearby fishing vessels, or other related aides to navigation. As one example, if it is desired to scatter mammals from a region, a boat 26 having one or more air guns 10 deployed below the waterline may navigate a particular pattern based upon GPS or similar positioning information, whereby the gun(s) would be triggered within a defined region in order to provide a specific territory that is substantially void of marine mammals.

As illustrated in FIGS. 9 and 10, the movable system includes a source of compressed fluid (e.g., gas) 42, which may include compressed gas storage tanks (e.g., FIG. 4) as well as powered compressors and associated tanks. As will be described herein, the pressure available from the tanks 42, provided to the gun(s) 10, may be controlled or regulated by one or more regulators to achieve a desired acoustic signal from the gun(s). The pressurized fluid source is connected to the gun via a hose 40 that receives pressurized fluid when valve 112 is opened and regulated via regulator 114. The gun is controlled by signals from controller 30 that are transmitted via cable 32. Moreover, as illustrated in FIG. 9, a remote trigger 116 may be employed to permit an observer on the boat to initiate firing of the gun(s). As illustrated, the control signal cable 32 and pressurized air hose 40 are combined, along with a support tether (not shown) into a harness 118 that suspends the air gun at a depth D, which is generally at least about 10 feet below the waterline. As will be further appreciated, the movable deterrent system may be affixed within the boat 26 or may be portable so as to be set up on or within any vessel. In a permanently mounted system, it may be the case that larger compressed gas storage tanks, or possibly an on-board compressor may be employed to provide the necessary source of compressed fluid (gas).

As noted above, alternative acoustic impulse sources may be employed in the deterrent embodiments disclosed herein. In addition to the air guns disclosed, such sources may include other fluid-powered acoustic sources such as water guns. While other types of acoustic sources are contemplated for control by the disclosed system, for example, possibly sleeve exploders of the oxy/acetylene type, pyrotechnic sources (e.g., seal bombs, shaped explosives, detonation cord), and the like, such sources may require alternative control signals. As it is further contemplated that deterrent systems, and in particular the various gun arrays, may be constructed using the same or alternative acoustic impulse sources, particularly in situations where alternative sound sources are preferred. In such cases, it is understood that the controls described herein may be similarly employed to at least regulate the timing of such sources to achieve the desired deterrent effect on the mammals in the water. Further contemplated is the use of one or more continuous wave acoustic sources (e.g., a Hydroacoustic Low Frequency (HLF) source by Hydroacoustics, Inc., Henrietta, N.Y.). Such a source generates energy at individual frequencies as done in most continuous wave systems, however, to prove effective the source would likely have to be modified or controlled in a manner to simulate an impulse signal.

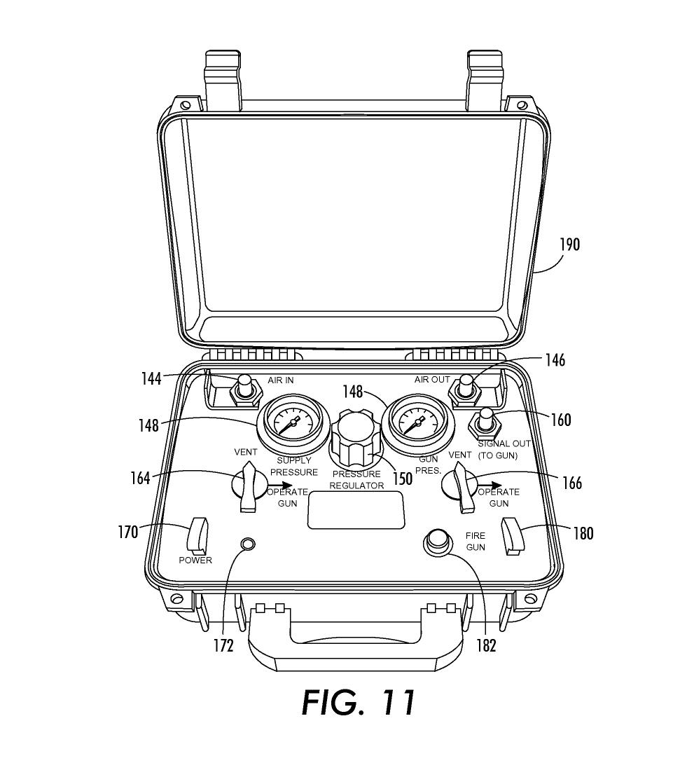

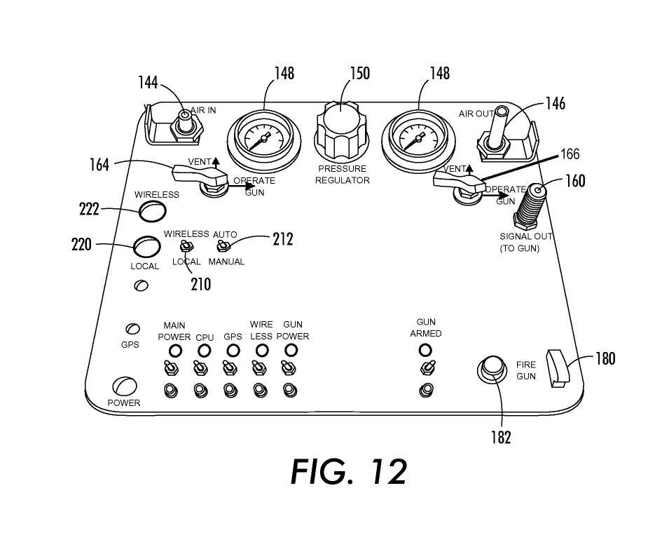

Turning next to FIGS. 11 and 12, depicted therein are illustrations of various controllers that may be employed for use in accordance with various embodiments. FIG. 11 illustrates a local controller 140 that includes an air supply connection 144 and an air output (to gun) 146. As noted previously, the air supply port is connected to the air source (e.g., high-pressure tank 42 in FIG. 4) and the air output is connected to the gun(s) 10 (e.g., FIGS. 3, 4 and 10) via a high pressure air hose. The air supply and output (gun) pressure may be determined by way of gauges 148, and the output pressure regulated or controlled via a regulator 150. As will be appreciated in an automated installation, the pressure regulation, as well as automated recharging of the pressure source may be accomplished automatically by a controller (e.g., microcontroller, computer, etc.) associated with the system as well as components responsive to signals from such devices.

Signal jack 160 is provided for interconnection with control signal cable 32 (e.g., FIG. 10) and provides the triggering signal(s) to the gun(s) in response to user input on the control console. Switches 164 and 166 are, respectively, valves suitable to assure that the supply air and output to the gun(s) are either connected to supply air to the guns or vent to the atmosphere. As will be appreciated, the valves should be in a vented position at any time the high-pressure connections 144 and 146 are not present or are being connected/disconnected. When placed in the “operate gun” position the valves serve to connect the pressurized source to the gun, via regulator 150. The local controller of FIG. 11 further includes a power switch 170 and indicator light 172, as well as a gun triggering or firing mechanism represented by toggle switch 180 and button 182. To initiate firing of the gun(s) connected to the controller, a user must first move the toggle switch 180 to an “on” or “armed” position and then depress the firing button 182. As illustrated, the various components associated with the controller may be enclosed with a case 190 to facilitate the transportation and use of the controller in various environments.

In a similar manner, FIG. 12 illustrates the various controls on the face of a controller that is suitable for use in various configurations. In order to illustrate several features of controller 30 in FIG. 12, its operation will be described. In a local configuration, using manual triggering (switches 210 and 212 in downward position), the system triggers the gun(s) using the dual-switch system (180, 182) as described above. In the local, automatic mode (switch 210 down and 212 up), the controller receives a triggering signal via a wired interface (e.g., through control jack 220) and automatically initiates a programmatically controlled firing sequence (single or multiple triggers). As will be appreciated, such a sequence could also be initiated in response to global positioning system (GPS) coordinates (e.g., firing when within range of particular coordinates, firing around a perimeter of a range based upon coordinates of a fishing vessel, etc.). In the wireless, manual mode (switch 210 up and 212 down) the system is responsive only to a triggering signal received from a wireless receiver that is responsive to a wireless transmitter (not shown). The output of the receiver would be plugged into jack 222 and would provide the triggering signal. In this manner someone in proximity to the controller (e.g., an observer walking the perimeter of a floating barge, etc.) may trigger the gun(s) by signaling with a remote transmitter. In the wireless, automatic mode (both switches up), the controller receives a triggering signal via a wireless interface connected to control jack 222) or otherwise automatically initiates a programmatically controlled firing sequence (single or multiple triggers).

The controller of FIG. 12 includes additional switches and indicator lights suitable for representing the operating state or condition of the controller. As will be appreciated, the CPU indicator represents the operational state of the computing device that itself executes programmatic control of the firing sequence and timing of the gun(s) in order to provide acoustic signals that deter mammals yet reduce the likelihood of habituation.

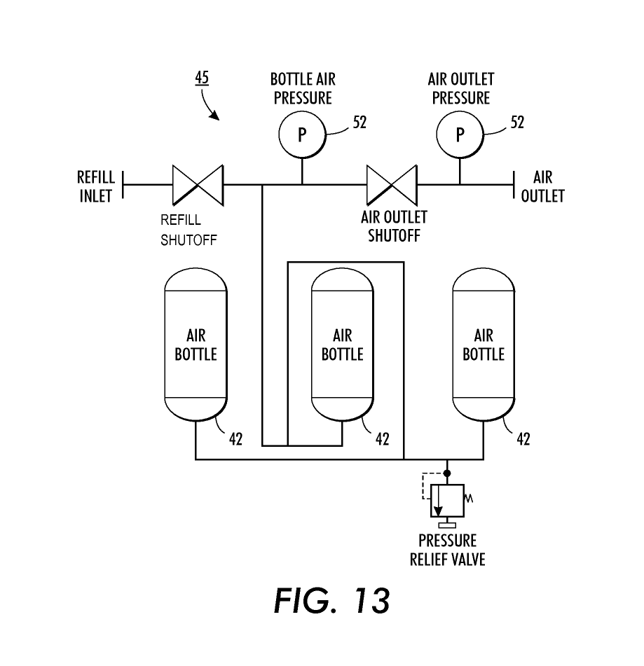

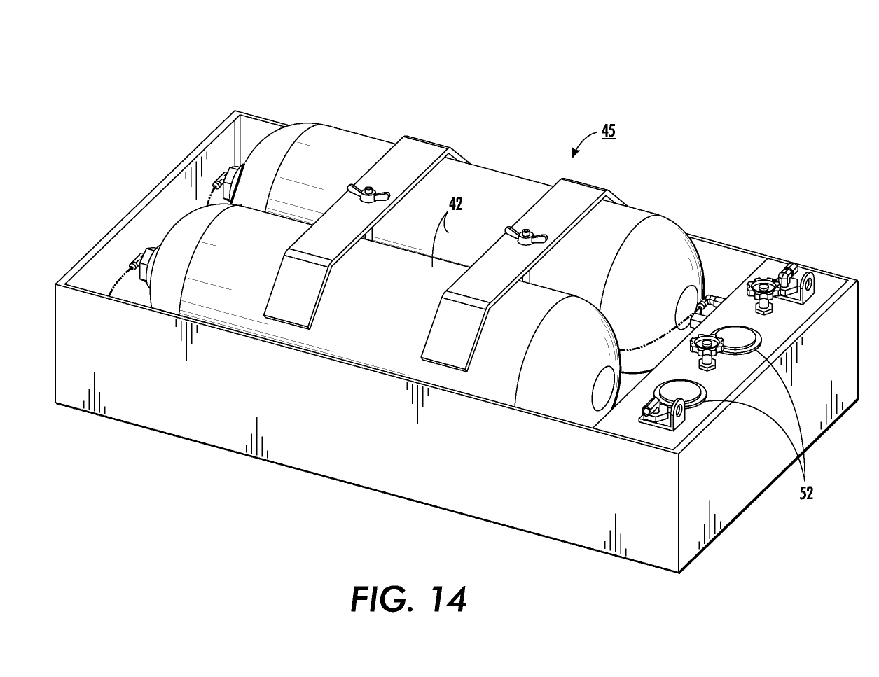

Referring next to FIGS. 13 and 14, depicted therein are exemplary compressed fluid (gas) energy storage systems for use in association with one or more of the embodiments disclosed herein. The schematic illustration of FIG. 13 corresponds to the three-tank system depicted in FIG. 4. Compressed air system 45 includes not only gauges 52 to monitor the pressure of the gas stored in the tanks 42, but valves to permit the filling and use of the stored air. Moreover, as will be appreciated, the tanks are interconnected to combine the respective storage capacities. Turning to FIG. 14, depicted therein is a view of a compressed air storage system where two tanks 42 are employed, again with pressure gauges and valves permitting the tanks to be charged and subsequently used as the source of pressurized fluid (air).

It should be further appreciated that the local or wireless input jacks may be connected to detection sensors or a system incorporating such sensors, to receive signals for triggering the firing of the gun(s) in response to the detection of mammals at or near a perimeter of the region to be protected. It is also contemplated that the programmatic control may enable one or more of the guns to produce a wave train of individual pulses, as well as the capability to superimpose tones on a broadband signal. While not depicted in the example in FIG. 12, the controller may include additional jacks 160 so that other guns or different guns within an array can be independently controlled and thereby facilitate additional flexibility in the manner and type of acoustic signals that may be created.

Another contemplated embodiment involves the complementary use of the disclosed deterrent system components. For example, in certain situations it may be desired to use the acoustic impulse capabilities of the system to shock or otherwise impede the sea life within the nets and cages that the system protects before introducing new fish into the controlled region in order to purge the area of any undesirable marine life. In such situations, the control system and associated acoustic impulse sources may be set to provide pulses having an energy level or profile sufficient to shock or kill marine life within the perimeter and thereby eliminate competitive marine life therein. It is also contemplated that the deterrent system could be similarly employed to assist in harvesting the fish within the caged area by providing a non-lethal, but stunning pulse(s), that may cause the fish to rise to the surface where they can more easily be harvested.

Furthermore, while embodiments have been described with reference to marine environments, it is to be appreciated that the principles of the disclosed embodiments can be equally applied for the deterrence of any mammal, in sea or on land. The advantages applicable to the fish farm industries could be equally applicable to other industries such as in controlling game preserves, in real estate management, or in protecting or defending permanent or mobile marine or non-marine assets.

It will be appreciated that variations of the above-disclosed embodiments and other features and functions, or alternatives thereof, may be desirably combined into many other different systems or applications. Also, various presently unforeseen or unanticipated alternatives, modifications, variations or improvements therein may be subsequently made by those skilled in the art which are also intended to be encompassed by the following claims.

What is claimed is:

1. A method for deterring mammals from remaining in a region of water, comprising:
detecting the presence of mammals near the region; and
in response to such detection, producing broadband acoustic signals from at least one fluid-powered acoustic impulse source regulated by a controller.

2. The method according to claim 1 wherein the broadband acoustic signals are emitted in response to a sensor signal generated upon detecting the presence of at least one mammal in the region.

3. The method according to claim 1 wherein the acoustic impulse source is controlled by said controller to produce individual pulses.

4. The method according to claim 1 wherein the acoustic impulse source is controlled by said controller to produce a wave train of individual pulses.

5. The method according to claim 4, wherein the wave train of individual pulses has a variable repetition rate.

6. The method according to claim 1 wherein a plurality of acoustic impulse sources are controlled to create tones on a broadband signal.

7. The method according to claim 1 wherein underwater sensors are used to detect the presence of mammals in proximity to the region of water and to provide signals indicating the presence of mammals to the controller.

8. The method according to claim 1, wherein the low-frequency, broadband acoustic signals are provided by a source selected from the group consisting of:
an air-gun,
a sleeve exploder,
a poppet valve, and
a water gun.

9. The method according to claim 1, wherein the low-frequency, broadband acoustic signals are provided by a source selected from the group consisting of:
a continuous wave source,
an explosive source,
a seal bomb,
a shaped explosive, and
detonation cord.

10. A system for repelling marine mammals from a region of water, comprising:
at least one fluid-powered acoustic impulse source deployed in the water in proximity to a perimeter of the region; and
a controller, controlling the operation of said acoustic impulse source to produce low-frequency, broadband acoustic signals.

11. The system according to claim 10, wherein the acoustic impulse source is fixed in association with the region of water.

12. The system according to claim 10, wherein the acoustic impulse source is movable relative to the region of water.

13. The system according to claim 10, wherein the acoustic impulse source produces a variable, low-frequency acoustic signal.

14. The system according to claim 13, wherein the low-frequency acoustic signals are provided by an acoustic impulse source selected from the group consisting of: an air-gun, a sleeve exploder, and a water gun.

15. The system according to claim 10, wherein a plurality of acoustic impulse sources are employed and wherein the system is capable of generating a plurality of different wave trains in response to signals from said controller.

16. The system according to claim 10, further including sensors to detect the presence of mammals in proximity to the region of water, and to provide signals indicating the presence of mammals to the controller.

17. The system according to claim 16, wherein at least some of said sensors are located beneath the surface of the water.

18. A method for deterring mammals from remaining in a region of water, comprising:
detecting the presence of mammals near the region using a sensor; and
in response to such detection and regulated by a controller, emitting broadband acoustic signals from at least one fluid-powered acoustic impulse source.

19. The method according to claim 18, wherein the broadband acoustic signals are low frequency and are emitted by a source selected from the group consisting of:
a continuous wave source,
an air-gun,
a sleeve exploder,
a poppet valve, and
a water gun.
